(19) United States
(12) Patent Application Publication
(10) Pub. No.: US 2025/0354731 A1
(43) Pub. Date: Nov. 20, 2025

(54) REFRIGERANT MANIFOLD AND REFRIGERANT MODULE INCLUDING SAME

(71) Applicant: Hanon Systems, Daejeon (KR)

(72) Inventors: Sangyong RHEE, Daejeon (KR); Dong Suk LEE, Daejeon (KR); Young Wook CHO, Daejeon (KR); Seung Kyu OH, Daejeon (KR); Da Won LEE, Daejeon (KR); Hak Kyu KIM, Daejeon (KR); Sang Ok LEE, Daejeon (KR)

(73) Assignee: Hanon Systems, Daejeon (KR)

(21) Appl. No.: 19/121,217

(22) PCT Filed: Oct. 13, 2023
(86) PCT No.: PCT/KR2023/015833

§ 371 Date: Apr. 15, 2025

(30) Foreign Application Priority Data
Oct. 19, 2022 (KR) 10-2022-0134731
Oct. 4, 2023 (KR) 10-2023-0131600

(51) Int. Cl. F25B 41/42; F25B 41/20

(52) U.S. Cl. CPC F25B 41/42; F25B 41/20

(57) ABSTRACT

The present invention relates to a refrigerant module. In the refrigerant module, devices related to a vehicle cooling system can be coupled to one side of each of a first housing and a second housing which are coupled to each other while having a middle plate interposed therebetween, a first groove portion is formed in the first housing which is coupled with the second housing, a communication hole is formed in a middle plate, and a second groove portion is formed in the second housing, thereby forming a fluid channel for the refrigerant to flow inside the refrigerant module.

### TECHNICAL FIELD

The present invention relates to a refrigerant manifold and a refrigerant module including the same, and more specifically, to a refrigerant manifold formed by coupling a first housing, a second housing, and a middle plate so that devices related to a vehicle cooling system may be coupled to the outside and a flow path through which refrigerant may flow is formed therein, and a refrigerant module including the same.

### BACKGROUND ART

To increase energy efficiency and solve environmental pollution problems, interest in eco-friendly vehicles that can replace internal combustion engine vehicles has been increasing recently.

The eco-friendly vehicles include electric vehicles driven by fuel cells or electricity, and hybrid electric vehicles driven by an engine and a battery, and unlike conventional internal combustion engine vehicles, the electric vehicles and the hybrid electric vehicles do not use a separate heater but use an air conditioning system called a heat pump system.

Such a heat pump system enables refrigerant modularization by coupling devices related to a vehicle cooling system, and conventionally, a refrigerant module of a heat pump system is formed by coupling devices related to a vehicle cooling system to a manifold.

In this way, to form the refrigerant module by coupling the devices related to the vehicle cooling system to the manifold, it is necessary to form a manifold so that refrigerant can flow inside the manifold and move between the devices related to the vehicle cooling system, and thus conventionally, a manifold in which a flow path along which refrigerant can flow is formed inside the refrigerant module has been used.

However, in the case of forming the refrigerant module using the manifold in which the flow path along which refrigerant can flow inside the manifold, there is a problem that a manufacturing cost of the manifold increases to form the flow path along which refrigerant can flow inside the manifold.

In addition, since the manifold in which the flow path is formed has a relatively large volume due to the flow path formed therein, there is a problem that the width, length, and height of the refrigerant module formed by coupling the manifold and devices related to the vehicle cooling system relatively increase.

In addition, there is a problem that manufacturing the manifold in which the flow path is formed requires high manufacturing difficulty.

### DISCLOSURE

### Technical Problem

The present invention is directed to providing a refrigerant manifold to which devices related to a vehicle cooling system are coupled and of which a width, length, and height can be minimized, and a refrigerant module including the same.

The present invention is also directed to providing a refrigerant manifold in which a flow path along which refrigerant flows is easily formed therein and which may be formed at a low manufacturing cost, and a refrigerant module including the same.

The present invention is also directed to providing a refrigerant manifold capable of being easily coupled to a component such as a pipe of a vehicle when installed on the vehicle, and a refrigerant module including the same.

Objects of the present invention are not limited to the above-described objects, and other objects that are not mentioned will be able to be clearly understood by those skilled in the art from the following description.

### Technical Solution

To achieve the above objects, a refrigerant manifold according to one embodiment of the present invention may include a first housing in which at least one first connection part to be connected to one of devices related to a vehicle cooling system is formed on one surface thereof and a first groove part is formed to be engraved in the other surface, a second housing in which at least one second connection part to connected to one of the devices related to a vehicle cooling system is formed on one surface thereof and a second groove part is formed to be engraved in the other surface, and a middle plate of which one surface is coupled to the other surface of the first housing so that the first groove part forms a plurality of first flow paths and the other surface is coupled to the other surface of the second housing so that the second groove part forms a plurality of second flow paths, and in which a plurality of communication holes that allows the first flow path to communicate with the second flow path are formed.

In addition, refrigerant introduced through each of the first flow paths may pass through the communication hole and flow into the second flow path that communicates with each of the first flow paths, and refrigerant introduced through each of the second flow paths may pass through the communication hole and flow into the first flow path that communicates with each of the second flow paths.

In addition, a first connection hole may be formed in the first connection part to communicate with the first flow path, and a second connection hole may be formed in the second connection part to communicate with the second flow path.

In addition, the first connection part may include a first valve connection part to which a first valve is connected, a second valve connection part to which a second valve is connected, and a third valve connection part to which a third valve is connected, and the first connection hole may include a first valve connection hole, a second valve connection hole, and a third valve connection hole.

In addition, the second connection part may include a chiller connection part to which a chiller is connected, and the second connection hole may include a chiller inlet connection hole and a chiller outlet connection hole.

In addition, the second connection part may include a water-cooled condenser connection part to which a water-cooled condenser is connected, and the second connection hole may include a water-cooled condenser inlet connection hole and a water-cooled condenser outlet connection hole.

In addition, the second connection part may include a heat pump connection part, and the second connection hole may include a heat pump connection hole.

In addition, at least one third connection part to be connected to one of the devices related to the vehicle cooling system may be formed on a side surface of the first housing, and at least one fourth connection part to be connected to one of the devices related to the vehicle cooling system may be formed on a side surface of the second housing.

In addition, a first side hole may be formed in the third connection part to communicate with the first flow path, and a second side hole may be formed in the fourth connection part to communicate with the second flow path.

In addition, the middle plate may be formed so that one surface and the other surface are formed flat, and the other surface of the first housing in contact with the middle plate and the other surface of the second housing in contact with the middle plate may be formed flat.

In addition, the middle plate may have a shape that seals the first groove part so that the first groove part forms the first flow path and a shape that seals the second groove part so that the second groove part forms the second flow path.

In addition, the first groove part may be formed as one or more first grooves, and each of the first grooves may communicate with one or more first connection holes or one or more first side holes, and the second groove part may be formed as one or more second grooves, and each of the second grooves may communicate with one or more second connection holes or one or more second side holes.

In addition, the first housing may include a flow path control part in which a predetermined portion of the first flow path is formed to control a moving path of a fluid flowing in the predetermined portion of the first flow path, the predetermined portion of the first flow path may communicate with the predetermined communication hole formed in the middle plate, the predetermined communication hole may communicate with a predetermined portion of the second flow path, and refrigerant flowing inside the predetermined portion of the second flow path may pass through the predetermined communication hole and flows into the predetermined portion of the first flow path.

In addition, the flow path control part may be formed as a ball valve.

To achieve the above objects, a refrigerant module according to one embodiment of the present invention may include the above-descried refrigerant manifold, a water-cooled condenser coupled to the refrigerant manifold, a battery chiller coupled to the refrigerant manifold, and a plurality of multi-way valves coupled to the refrigerant manifold.

Detailed matters of other embodiments for solving the objects are included in a detailed description and accompanying drawings.

### ADVANTAGEOUS EFFECTS

According to the above-described configuration, since the refrigerant manifold and the refrigerant module including the same are formed so that the devices related to the vehicle cooling system are coupled to each of one surfaces of the first housing and the second housing coupled with the middle plate interposed therebetween, it is possible to minimize the widths, lengths, and heights of the refrigerant manifold and the refrigerant module including the same.

In addition, since the flow path along which refrigerant inside the refrigerant manifold flows is formed by coupling the first housing in which the first groove part is formed, the middle plate in which the communication hole is formed, and the second housing in which the second groove is formed, the refrigerant manifold and the refrigerant module including the same can be easily formed at a low manufacturing cost.

In addition, since the third connection part and the fourth connection part are formed on the side surface of the refrigerant manifold, the refrigerant manifold and the refrigerant module including the same can be easily coupled to the component such as the pipe of the vehicle when installed on the vehicle.

### DESCRIPTION OF DRAWINGS

FIG. 1 is a view illustrating a refrigerant manifold according to one embodiment of the present invention.

FIG. 2 is an exploded perspective view of the refrigerant manifold.

FIG. 3 is a view illustrating a first housing.

FIG. 4 is a view illustrating a second housing.

FIG. 5 is a view illustrating a middle plate.

FIG. 6 is a view illustrating a cross section of the refrigerant manifold.

FIG. 7 is a view illustrating a refrigerant module including the refrigerant manifold of FIG. 1.

### MODE FOR INVENTION

Hereinafter, embodiments of the present application will be described in detail with reference to the accompanying drawings so that those skilled in the art to which the present application pertains may easily carry out the present application. However, the present application may be implemented in various different forms and is not limited to the embodiments described herein. In addition, to clearly describe the present application in the drawings, components irrelevant to the description have been omitted, and throughout the specification, similar components have been denoted as similar reference numerals.

Throughout the specification of the present application, when a certain component is described as being “connected to” another component, it includes not only a case in which the certain component is “directly connected” to another component, but also a case in which the certain component is “electrically connected” to another component with still another component interposed therebetween.

Throughout the specification of the present application, when a certain member is described as being positioned “on” another member, it includes not only a case in which the certain member is in contact with another member but also a case in which still another member is present between the two members.

Throughout the specification of the present application, when a certain portion is described as “including” a certain element, it means that the certain portion may further include other elements rather than precluding other elements unless specifically stated to the contrary. Terms “about,” “substantially,” or the like used throughout the specification of the present application are used to mean a numerical value or the approximation of the numerical value when unique manufacturing and material tolerances are presented to stated meaning and are used to prevent infringers from unfairly using the disclosed content in which accurate or absolute values are mentioned to help the understanding of the present application. Terms “operation of ˜ (ing)” or “operation of” used throughout the specification of the present application do not mean “operation for.”

Hereinafter, exemplary embodiments of the present invention will be described in detail with reference to the accompanying drawings and contents to be described below. However, the present invention is not limited to the embodiments described herein and may also be specified in other forms. The same reference numbers denote the same components throughout the specification.

Hereinafter, a configuration of a refrigerant manifold according to one embodiment of the present invention will be described.

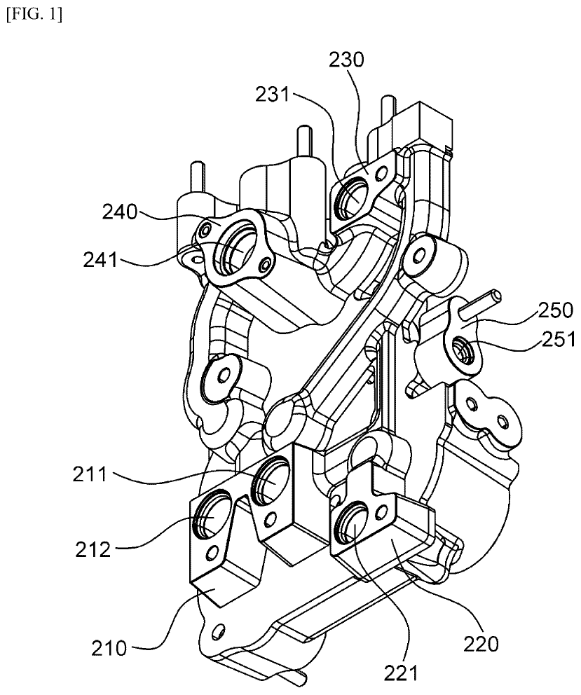

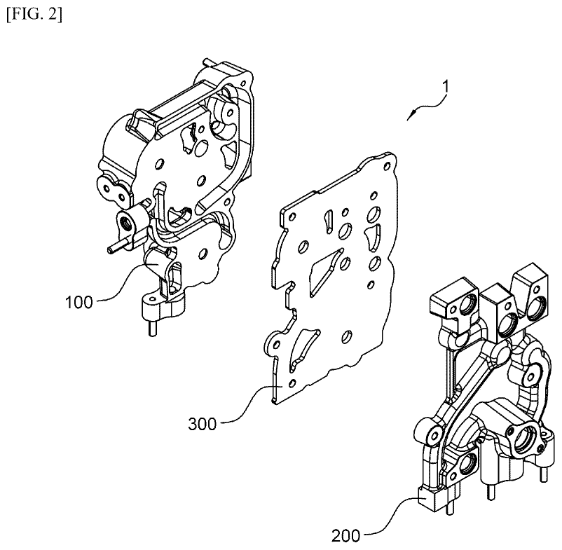

FIG. 1 is a view illustrating a refrigerant manifold according to one embodiment of the present invention, and FIG. 2 is an exploded perspective view of the refrigerant manifold.

Referring to FIGS. 1 and 2, a refrigerant manifold 1 may include a first housing 100, a second housing 200, and a middle plate 300, and the first housing 100 and the middle plate 300, and the middle plate 300 and the second housing 200 may be formed to be coupled.

For example, the refrigerant manifold 1 may be formed by coupling the first housing 100 to the middle plate 300 through a brazing process and coupling the middle plate 300 to the second housing 200 through a brazing process.

First, the first housing 100 will be described.

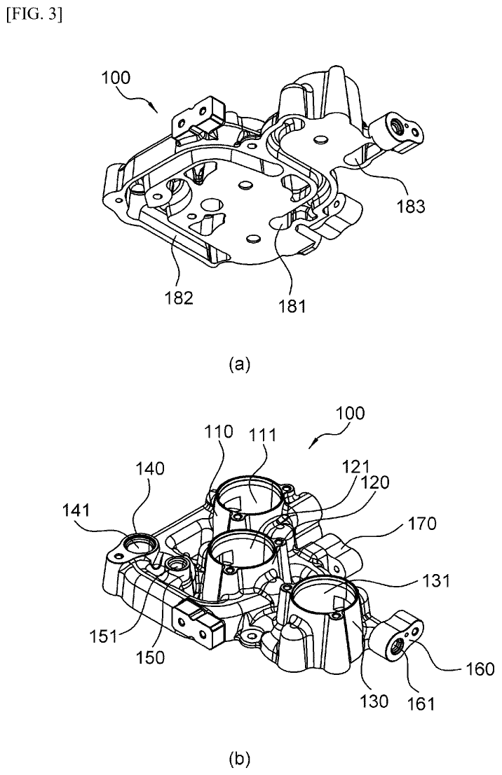

FIG. 3 is a view illustrating a first housing.

Referring to FIG. 3, the first housing 100 may have at least one first connection part, which may be connected to one of devices related to a vehicle cooling system, formed on one surface thereof (see FIG. 3B).

In this case, the device related to the vehicle cooling system may be any one of an expansion valve, an accumulator, a condenser, an air-cooled condenser, an indoor unit, an evaporator, a heat pump, a water-cooled condenser, and a chiller.

The first connection part may be formed to protrude a predetermined height from the one surface of the first housing 100 to be connected to one of the devices related to the vehicle cooling system.

A first connection hole may be formed in the first connection part to communicate with a first flow path to be described below. By forming the first connection hole in the first connection part, refrigerant may flow from one of the devices related to the vehicle cooling system connected to the first connection part to the first flow path, or the refrigerant may flow from the first flow path to one of the devices related to the vehicle cooling system connected to the first connection part.

For example, as illustrated in FIG. 3, the first connection part and the first connection hole may include a first valve connection part 110 to which a first valve is connected and a first valve connection hole 111, a second valve connection part 120 to which a second valve is connected and a second valve connection hole 112, and a third valve connection part 130 to which a third valve is connected and a third valve connection hole 131.

In addition, the first connection part and the first connection hole may include an accumulator connection part 140 to which an accumulator is connected and an accumulator connection hole 141.

In addition, the first connection part and the first connection hole may include a PT sensor connection part 150 to which a PT sensor is connected and a PT sensor connection hole 151.

In this case, the first valve, the second valve, and the third valve may be formed as a multi-way valve such as a three-way valve.

The first housing 100 may have a first groove part formed to be engraved in the other surface (see FIG. 3A).

When the first housing 100 is coupled with the middle plate 300 to be described below, the first groove part may be sealed by the middle plate 300 to form a plurality of first flow paths, and refrigerant may flow inside the first flow paths.

The first groove part may be formed as one or more first groove 181, 182, and 183, and each of the first grooves 181, 182, and 183 may communicate with at least one first connection hole or a first side hole to be described below.

For example, as illustrated in FIG. 3, the first groove 182 may be formed to communicate with a heat pump, an expansion valve, and an air-cooled condenser, and the first groove 183 may be formed to communicate with an evaporator.

In addition, the first housing 100 may have at least one third connection part, which may be connected to one of the devices related to the vehicle cooling system, formed on a side surface thereof.

The third connection part may be formed to protrude a predetermined height from the side surface of the first housing 100 to be connected to one of the devices related to the vehicle cooling system.

A first side hole may be formed in the third connection part to communicate with the first flow path. By forming the first side hole in the third connection part, refrigerant may flow to one of the devices related to the vehicle cooling system connected to the third connection part.

For example, as illustrated in FIG. 3, the third connection part and the first side hole may include an air-cooled condenser connection part 170 to which an air-cooled condenser is connected, an air-cooled condenser side hole, an evaporator connection part 160 to which an evaporator is connected, and an evaporator side hole 161.

Subsequently, the second housing 200 will be described.

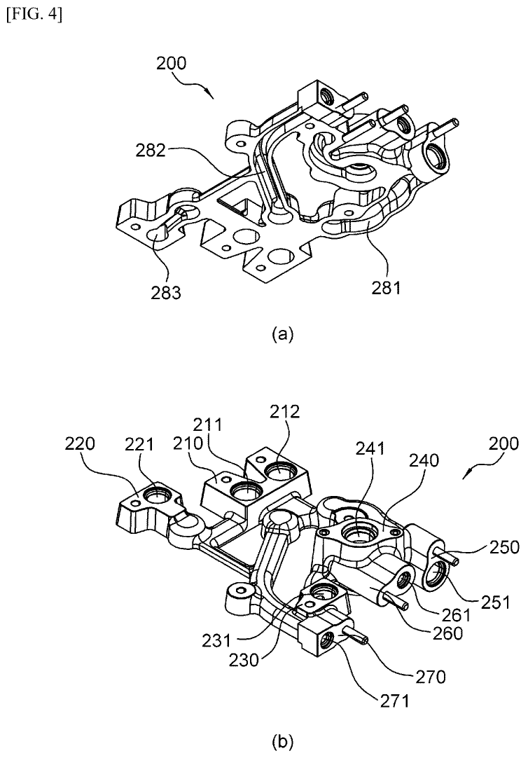

FIG. 4 is a view illustrating a second housing.

Referring to FIG. 4, the second housing 200 may have at least one second connection part, which may be connected to one of devices related to a vehicle cooling system, formed on one surface thereof (see FIG. 4B).

The second connection part may be formed to protrude a predetermined height from the one surface of the second housing 200 to be connected to one of the devices related to the vehicle cooling system.

A second connection hole may be formed in the second connection part to communicate with a second flow path to be described below. By forming the second connection hole in the second connection part, refrigerant may flow from one of the devices related to the vehicle cooling system connected to the second connection part to the second flow path, or the refrigerant may flow from the second flow path to one of the devices related to the vehicle cooling system connected to the second connection part.

For example, as illustrated in FIG. 4, the second connection part and the second connection hole may include a chiller connection part 210 to which a chiller is connected, a chiller inlet connection hole 211, and a chiller outlet connection hole 212.

In addition, the second connection part and the second connection hole may include water-cooled condenser connection parts 220 and 230 to which the water-cooled condenser is connected, a water-cooled condenser inlet connection hole 231, and a water-cooled condenser outlet connection hole 221.

In addition, the second connection part and the second connection hole may include a heat pump connection part 240 and a heat pump connection hole 241 connected to a heat pump.

The second housing 200 may have a second groove part formed to be engraved in the other surface (see FIG. 4A).

When the second housing 200 is coupled with the middle plate 300 to be described below, the second groove part may be sealed by the middle plate 300 to form a plurality of second flow paths, and refrigerant may flow inside the second flow paths.

The second groove part may be formed as one or more second groove 281, 282, and 283, and each of the second grooves 281, 282, and 283 may communicate with at least one second connection hole or a second side hole to be described below.

For example, as illustrated in FIG. 4, the second groove 281 may be formed to communicate with the evaporator and the accumulator, and the second groove 282 may be formed to communicate with the air-cooled condenser, the expansion valve, and the chiller.

In addition, the second housing 200 may have at least one fourth connection part, which may be connected to one of the devices related to the vehicle cooling system, formed on a side surface thereof.

The fourth connection part may be formed to protrude a predetermined height from the side surface of the second housing 200 to be connected to one of the devices related to the vehicle cooling system.

A second side hole may be formed in the fourth connection part to communicate with the second flow path. By forming the second side hole in the fourth connection part, refrigerant may flow from one of the devices related to the vehicle cooling system connected to the fourth connection part to the second flow path, or the refrigerant may flow from the second flow path to one of the devices related to the vehicle cooling system connected to the fourth connection part.

For example, as illustrated in FIG. 4, the fourth connection part and the second side hole may include an evaporator connection part 250 connected to the evaporator, an evaporator side hole 251, an indoor unit connection part 260 connected to the indoor unit, an indoor unit side hole 261, an air-cooled condenser connection part 270 connected to the air-cooled condenser, and an air-cooled condenser side hole 271.

Subsequently, the middle plate 300 will be described.

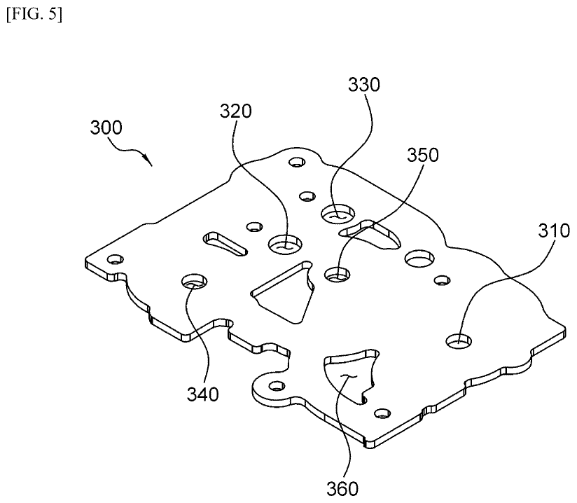

FIG. 5 is a view illustrating a middle plate.

Referring to FIG. 5, the middle plate 300 may be formed in a plate shape and may have one surface coupled to one surface of the first housing 100 so that the first groove part of the first housing 100 forms the first flow path and the other side coupled to the other surface of the second housing 200 so that the second groove part of the second housing 200 forms the second flow path.

In addition, at least one communication hole connecting the first flow path to the second flow path may be formed in the middle plate 300. By forming the communication hole in the middle plate 300, the refrigerant flowing into the first flow path from one of the devices related to the vehicle cooling system connected to the first connection part or the third connection part may flow into the second flow path through the communication hole, or the refrigerant flowing into the second flow path from one of the devices related to the vehicle cooling system connected to the second connection part or the fourth connection part may flow into the first flow path through the communication hole.

For example, as illustrated in FIG. 5, a communication hole including a communication hole 310 through which refrigerant flowing from the heat pump may pass, a communication hole 320 through which refrigerant flowing from the chiller may pass, and a communication hole 330 through which refrigerant discharged to the chiller may pass may be formed in the middle plate 300.

In addition, an empty space 360 may be formed in the middle plate 300. Specifically, the middle plate 300 may be formed so that an empty space is formed in the remaining part except for a part sealing the first groove part and the second groove part.

In this way, when the middle plate 300 is formed so that the empty space 360 is formed, not only may the materials for manufacturing the middle plate 300 be saved, but also the middle plate 300 becomes lighter, and thus the refrigerant manifold 1 including the middle plate 300 may be manufactured lighter.

In addition, the middle plate 300 may be formed so that one surface and the other surface are formed to be curved or formed flat. When the one surface and the other surface of the middle plate 300 are formed flat, the other surface of the first housing 100 in contact with the middle plate 300 and the other surface of the second housing 200 in contact with the middle plate 300 may also be formed flat.

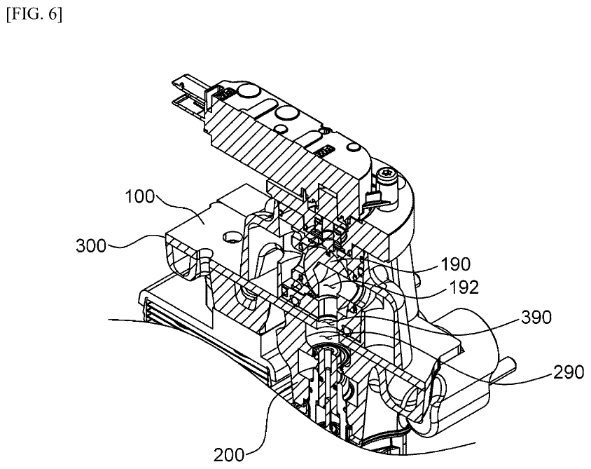

FIG. 6 is a view illustrating a cross section of the refrigerant manifold.

Meanwhile, as illustrated in FIG. 6, the first housing 100 may include a flow path control part 190 formed as a ball valve or the like therein to control a moving path of a fluid flowing therein, and a predetermined portion 192 of the first flow path may be formed inside the flow path control part 190.

In addition, the predetermined portion 192 of the first flow path formed inside the flow path control part 190 communicates with a predetermined communication hole 390 formed in the middle plate 300, and the predetermined communication hole 390 formed in the middle plate 300 communicates with a predetermined portion 290 of the second flow path.

Accordingly, the refrigerant flowing inside the predetermined portion 290 of the second flow path may pass through the predetermined communication hole 390 and flow into the predetermined portion 192 of the first flow path formed inside the flow path control part 190.

Hereinafter, a configuration of a refrigerant module 10 according to one embodiment of the present invention will be described.

The refrigerant module 10 may be formed by coupling the devices related to the vehicle cooling system with the refrigerant manifold 1.

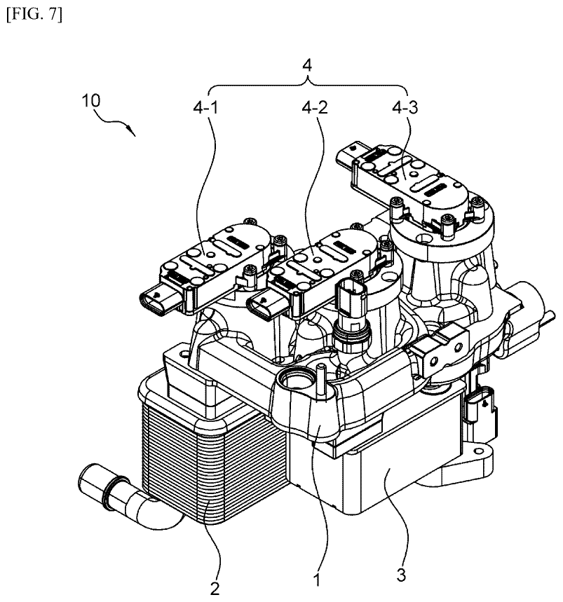

FIG. 7 is a view illustrating a refrigerant module including the refrigerant manifold of FIG. 1.

For example, as illustrated in FIG. 7, the refrigerant module 10 may include the refrigerant manifold 1, a water-cooled condenser 2 coupled to the refrigerant manifold 1, a chiller 3 coupled to the refrigerant manifold 1, and a plurality of three-way valves 4-1, 4-2, and 4-3 coupled to the refrigerant manifold 1.

Hereinafter, the operation and effect of the refrigerant manifold according to one embodiment of the present invention will be described.

The first housing 100 and the middle plate 300 are coupled, and the middle plate 300 and the second housing 200 are coupled to form the refrigerant manifold 1.

In this case, the first groove part formed in the first housing 100 is sealed by the middle plate 300 to form the first flow path, and the second groove part formed in the second housing 200 is sealed by the middle plate 300 to form the second flow path. In addition, the first flow path communicates with the second flow path by the communication hole formed in the middle plate 300.

Meanwhile, at least one of the devices related to the vehicle cooling system that allows refrigerant to be introduced through the first flow path or accommodates refrigerant discharged from the first flow path may be connected to the first housing 100, and at least one of the devices related to the vehicle cooling system that allows refrigerant to be introduced through the second flow path or accommodates refrigerant discharged from the second flow path may be connected to the second housing 200.

Accordingly, the refrigerant may flow from the device related to the vehicle cooling system connected to the first housing 100 to the device related to the vehicle cooling system connected to the second housing 200 or from the device related to the vehicle cooling system connected to the second housing 200 to the device related to the vehicle cooling system connected to the first housing 100.

In this way, since the refrigerant manifold and the refrigerant module including the same are formed so that the devices related to the vehicle cooling system are coupled to each of one surfaces of the first housing and the second housing coupled with the middle plate interposed therebetween, it is possible to minimize the widths, lengths, and heights of the refrigerant manifold and the refrigerant module including the same.

In addition, since the flow path along which refrigerant inside the refrigerant manifold flows is formed by coupling the first housing in which the first groove part is formed, the middle plate in which the communication hole is formed, and the second housing in which the second groove is formed, the refrigerant manifold and the refrigerant module including the same can be formed at a low manufacturing cost.

In addition, since the third connection part and the fourth connection part are formed on the side surface of the refrigerant manifold, the refrigerant manifold and the refrigerant module including the same can be easily coupled to the component such as the pipe of the vehicle when installed on the vehicle.

The above description of the present invention is for illustrative purpose, and those skilled in the art to which the present invention pertains will be able to understand that the present invention may be easily modified in other specific forms without changing the technical spirit or essential features thereof. Therefore, it should be understood that the above-described embodiments are illustrative and not restrictive in all respects. For example, each component described in a singular form may be implemented separately, and likewise, components described as being implemented separately may also be implemented in a combined form.

The scope of the present disclosure is defined by the appended claims rather than the detailed description, and all changes or modifications derived from the meaning and scope of the claims and equivalent concepts thereof should be construed as being included in the scope of the present disclosure.

1. A refrigerant manifold comprising:
a first housing in which at least one first connection part to be connected to one of devices related to a vehicle cooling system is formed on one surface thereof and a first groove part is formed to be engraved in the other surface;
a second housing in which at least one second connection part to connected to one of the devices related to a vehicle cooling system is formed on one surface thereof and a second groove part is formed to be engraved in the other surface; and
a middle plate of which one surface is coupled to the other surface of the first housing so that the first groove part forms a plurality of first flow paths and the other surface is coupled to the other surface of the second housing so that the second groove part forms a plurality of second flow paths, and in which a plurality of communication holes that allows the first flow path to communicate with the second flow path are formed.

2. The refrigerant manifold of claim 1, wherein refrigerant introduced through each of the first flow paths passes through the communication hole and flows into the second flow path that communicates with each of the first flow paths, and refrigerant introduced through each of the second flow paths passes through the communication hole and flows into the first flow path that communicates with each of the second flow paths.

3. The refrigerant manifold of claim 2, wherein a first connection hole is formed in the first connection part to communicate with the first flow path, and
a second connection hole is formed in the second connection part to communicate with the second flow path.

4. The refrigerant manifold of claim 3, wherein the first connection part includes a first valve connection part to which a first valve is connected, a second valve connection part to which a second valve is connected, and a third valve connection part to which a third valve is connected, and
the first connection hole includes a first valve connection hole, a second valve connection hole, and a third valve connection hole.

5. The refrigerant manifold of claim 4, wherein the second connection part includes a chiller connection part to which a chiller is connected, and the second connection hole includes a chiller inlet connection hole and a chiller outlet connection hole.

6. The refrigerant manifold of claim 5, wherein the second connection part includes a water-cooled condenser connection part to which a water-cooled condenser is connected, and the second connection hole includes a water-cooled condenser inlet connection hole and a water-cooled condenser outlet connection hole.

7. The refrigerant manifold of claim 6, wherein the second connection part includes a heat pump connection part, and the second connection hole includes a heat pump connection hole.

8. The refrigerant manifold of claim 3, wherein at least one third connection part to be connected to one of the devices related to the vehicle cooling system is formed on a side surface of the first housing, and
at least one fourth connection part to be connected to one of the devices related to the vehicle cooling system is formed on a side surface of the second housing.

9. The refrigerant manifold of claim 8, wherein a first side hole is formed in the third connection part to communicate with the first flow path, and
a second side hole is formed in the fourth connection part to communicate with the second flow path.

10. The refrigerant manifold of claim 9, wherein the middle plate is formed so that one surface and the other surface are formed flat, and
the other surface of the first housing in contact with the middle plate and the other surface of the second housing in contact with the middle plate are formed flat.

11. The refrigerant manifold of claim 10, wherein the middle plate has a shape that seals the first groove part so that the first groove part forms the first flow path and a shape that seals the second groove part so that the second groove part forms the second flow path.

12. The refrigerant manifold of claim 11, wherein the first groove part is formed as one or more first grooves, and each of the first grooves communicates with one or more first connection holes or one or more first side holes, and
the second groove part is formed as one or more second grooves, and each of the second grooves communicates with one or more second connection holes or one or more second side holes.

13. The refrigerant manifold of claim 12, wherein the first housing includes a flow path control part in which a predetermined portion of the first flow path is formed to control a moving path of a fluid flowing in the predetermined portion of the first flow path,
the predetermined portion of the first flow path communicates with the predetermined communication hole formed in the middle plate, and the predetermined communication hole communicates with a predetermined portion of the second flow path, and
refrigerant flowing inside the predetermined portion of the second flow path passes through the predetermined communication hole and flows into the predetermined portion of the first flow path.

14. The refrigerant manifold of claim 13, wherein the flow path control part is formed as a ball valve.

15. A refrigerant module of claim 14, comprising:
the refrigerant manifold of claim 1;
a water-cooled condenser coupled to the refrigerant manifold;
a battery chiller coupled to the refrigerant manifold; and
a plurality of multi-way valves coupled to the refrigerant manifold.
